(19) United States
(12) Patent Application Publication
(10) Pub. No.: US 2007/0034266 A1
(43) Pub. Date: Feb. 15, 2007

(54) Four-way valve

(76) Inventor: Ban-Chih Wang, Tai-Pin City (TW)

Correspondence Address: Liberty Patent and Trademark Office, P.o. Box 590, Taichung City, Taichung, 400, TW

(21) Appl. No.: 11/201,193

(22) Filed: Aug. 11, 2005

(51) Int. Cl. F16K 11/044

(52) U.S. Cl. 137/625.5

(57) ABSTRACT

A type of four-way valve, in the technical field of plastic processing, is designed to facilitate easy production and accurate control. The four-way valve has two inlets and two outlets, including: a container main having a movable cover and divided by four partition boards into five spaces. Each sidewall of its foremost space and hindmost space has a through hole that is respectively connected to a three-way pipe, each partition board has a vent groove, so that all spaces are communicating with each other; a cylinder having a spindle that is connected to a fore piston and hind piston penetrating four spaces from the fore part, the fore piston and the hind piston respectively located in the second space and the fourth space.

### BACKGROUND OF THE INVENTION

1. Field of the invention

The present invention relates to a plastic processing technical- field, involving peripheral equipment for plastic forming process, particularly a type of four-way valve having two inlets and two outlets, capable of switching combinations of corresponding exit and inlet relations.

2. Description of the Prior Art

FIGS. 1, 2 and 3 show the prior art of a four-way valve, wherein a rotating cylinder 90 serves to choose different channels (referring to the directions indicated by arrows in FIGS. 2 and 3). But it has some shortcomings. When the rotating cylinder 90 is deviated in its rotating operation, the outlets 911,912,913,914 of its ball valve 91 are not accurately aligned with the pipe outlets 921,922,923,924 of its main base 92, resulting in failure to achieve anticipated area of convection and irregular volume of flow; furthermore, the main base 92 is made of cast iron that has a high hardness and high difficulty in processing. Furthermore, the round ball valve groove 920 and its four outlet units 921,922,923,924, and the four outlet units 911,912,913,914 of the ball valve 91 require precision processing that is quite sophisticated and time consuming, resulting in high costs of production.

### SUMMARY OF THE INVENTION

The objective of this invention is to provide a four-way valve that is easy to produce and efficient in use.

The objective is realized as follows:

A type of four-way valve, having two inlets and two outlets, characterized in the following structure:

A container main, having five spaces divided by four partition boards, wherein each sidewall of its foremost space and hindmost space has a through hole that is connected respectively with a hind connecting pipe and a fore connecting pipe of a three-way pipe; furthermore, each of the partition boards has a vent groove to permit connection of all spaces;

A cover, covering and sealing a top side of the container main, and fastened by tightening members to the container main;

A cylinder, fastened to a fore side of the container main, having a cylinder spindle connected with a fore piston and a hind piston (having its fore end face and hind end face as sealing faces) to penetrate four spaces from the fore side; the fore piston and the hind piston respectively located in the second space and the fourth space of the container main; the difference between the length of an inside hollow of the second space and the thickness of the fore piston is approximately equal to the difference between the length of an inside hollow of the fourth space and the thickness of the hind piston.

In the production of the aforementioned structure, only a further processing is required on the vent grooves of the four partition boards of the container main and the contact parts of the fore and hind pistons. Therefore, the processing procedure can be simplified significantly, and processing time can be shortened to reduce processing costs. Meanwhile, accurate selection of combination of channels can be achieved merely by controlling linear and reciprocal movement of the cylinder spindle, and there will be no deviation of flow as can be found in a conventional four-way valve.

### BRIEF DESCRIPTION OF THE DRAWINGS

FIG. 1 is a perspective view of the prior art of four-way valve.

FIG. 2 is a sectional view of part of the prior art of four-way valve.

FIG. 3 is another sectional view of part of the prior art of four-way valve.

FIG. 4 is an exploded view of a preferred embodiment of the present invention.

FIG. 5 is an assembled perspective view of the embodiment of the invention.

FIG. 6 is a schematic plan view of the embodiment in operation.

FIG. 7 is another schematic plan view of the embodiment in operation.

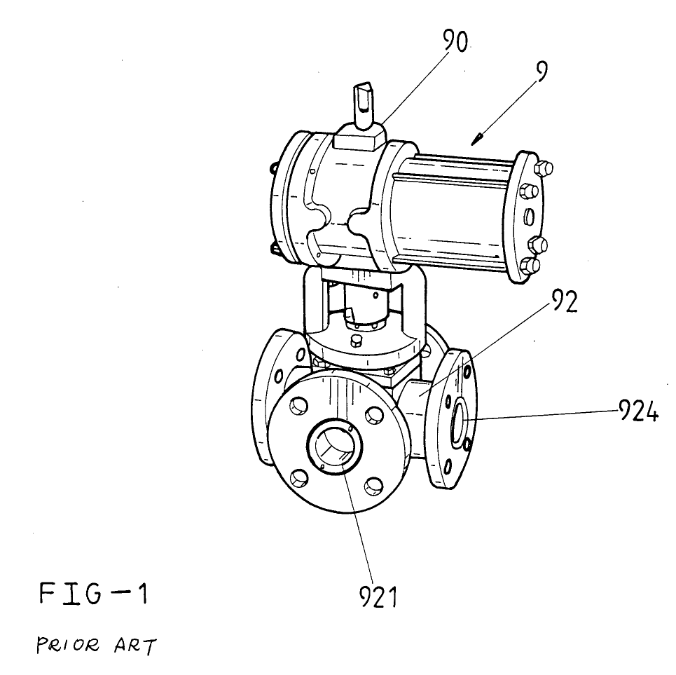

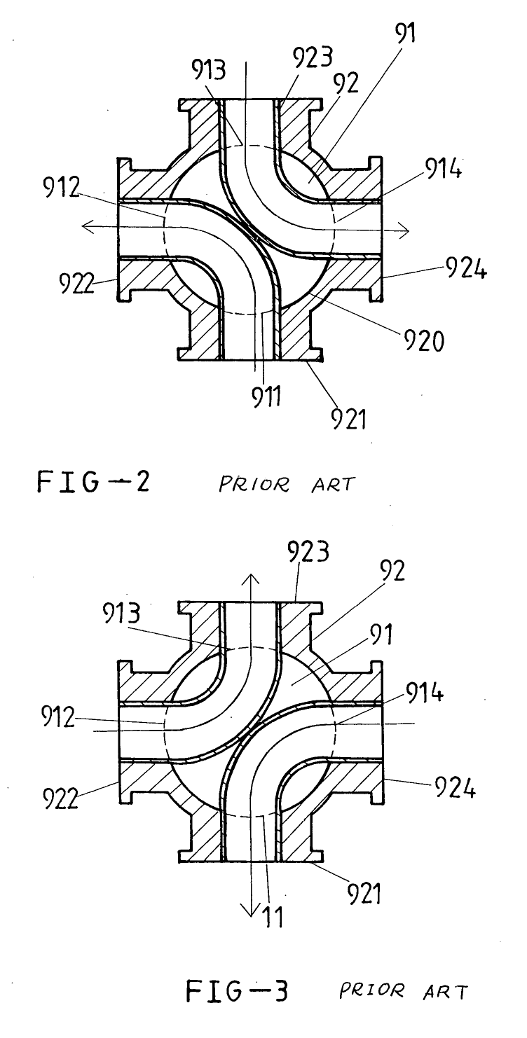

### DETAILED DESCRIPTION OF THE PREFERRED EMBODIMENT

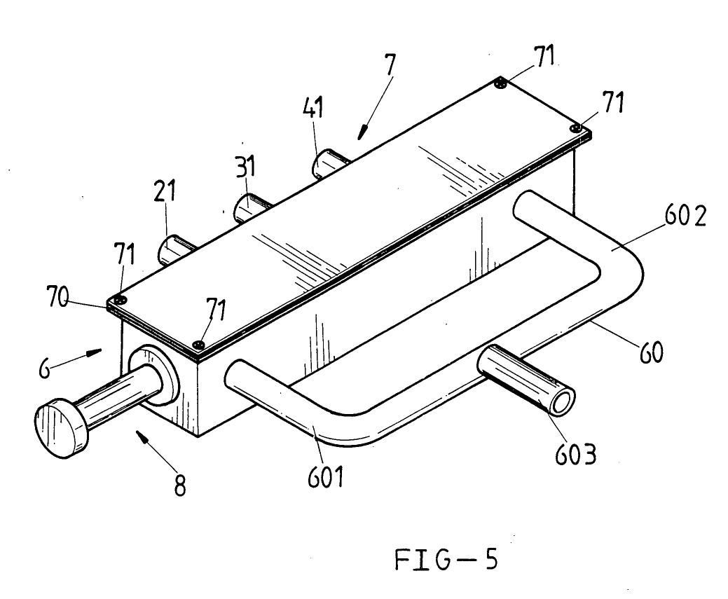

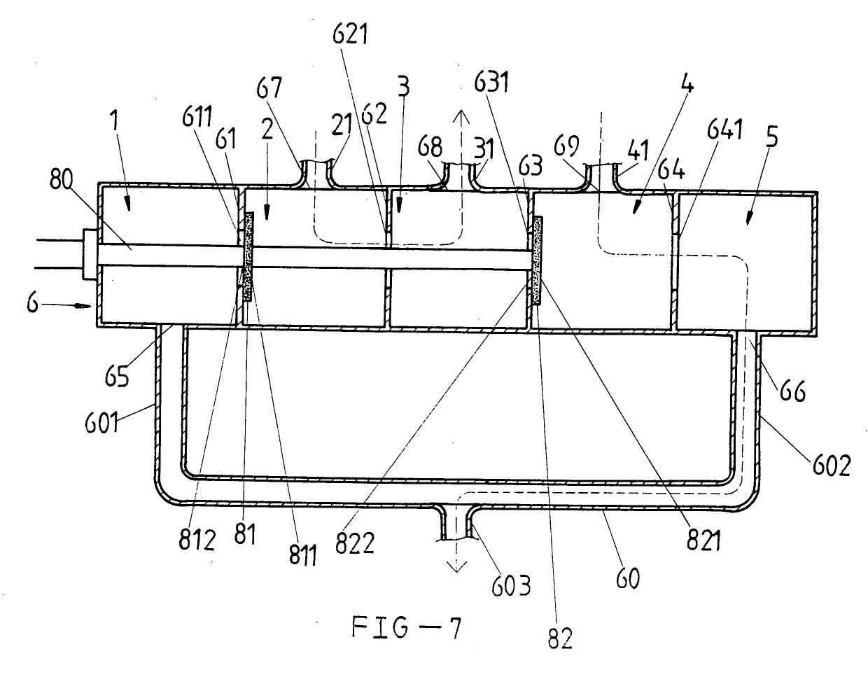

As shown in FIGS. 4 through 7, the present invention relates to a four-way valve, comprising:

a container main 6 is divided by four partition boards into five spaces 1, 2, 3, 4, 5, wherein, on a sidewall of a foremost space 1 and a hindmost space 5 are provided respectively a through hole 65, 66, respectively joining with a hind connecting pipe 601 and a fore connecting pipe 602 of a T-shaped three-way pipe 60. On another sidewall of the intermediate three spaces 2,3,4 in a container main 6 are respectively through holes 67, 68, 69, connecting respectively with connecting pipes 21, 31, 41. Each of the four partition boards 61, 62, 63, 64 has a vent groove 611, 621, 631, 641 connecting the spaces 1, 2, 3, 4, 5;

a sealing cover 7, used to cover and seal the top side of the container main 6, and to tighten the container main 6 with tightening members 71, 72.

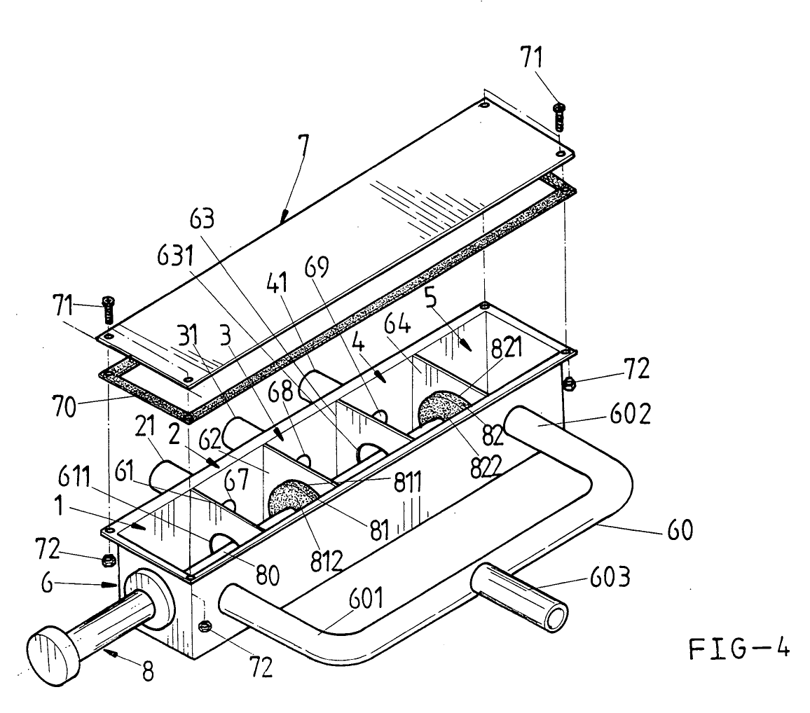

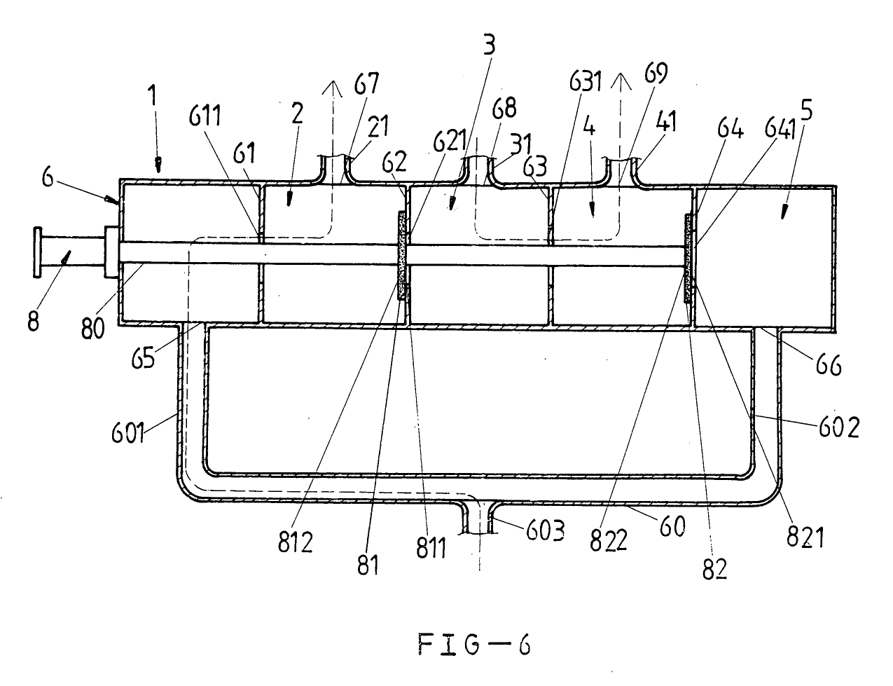

a cylinder spindle 80 connected with a fore piston 81 and a hind piston 82 respectively located in the second space 2 and the fourth space 4 in the container main 6; when the cylinder spindle 80 moves and extends forward (referring to FIGS. 3 and 5), a fore end face 821 of the hind piston 82 moves to block the vent groove 641 on the fourth partition board 64, and a fore end face 811 of the fore piston 81 moves to block the vent groove 621 on the second partition board 62, permitting connection between the third space 3 and the fourth space 4 of the container main 6; and by connecting the connecting pipes 31,41 with specified locations, the first space 1 and the second space 2 and the fifth space 5 are also connected; and a side pipe 603 of a T-shaped three-way pipe 60 and the connecting pipe 21 in the second space 2 are connected with specified locations; when the cylinder spindle 80 moves backward and retracts (referring to FIG. 6), a hind end face 822 of the hind piston 82 moves to block the vent groove 611 on the first partition board 61, and a hind end face 812 of the fore piston 81 moves to block the vent groove 631 on the third partition board 63; thereby, the second space 2 and the third space 3 of the container main 6 are connected, and by connecting the connecting pipes 21,31 respectively with specified locations, the fourth space 4 and the fifth space 5 and the first space 1 are connected, and the side pipe 603 of the T-shape three-way pipe 60 is connected with a specified location; therefore, moving the cylinder spindle 80 forward and backward is capable of controlling optional switching between four modes of connections.

Furthermore, the fore end face 811 and the hind end face 812 of the fore piston 81, and the fore end face 821 and the hind end face 822 of the hind piston 82, connected to the cylinder spindle 80 of the cylinder 8 in the container main 6 are made of rubber or other material with satisfactory airtight sealing performance.

Optionally, a pad unit 70 made of rubber or other material with satisfactory airtight sealing performance is fastened to a top margin of the container main 6.

Concluding the above, the present invention has the following characteristics:

Convenient production—since the container main 6 is aluminum cast to form, its materials can be processed easily. It requires only further processing on the vent grooves 611,621,631,641 on the four partition boards 61,62,63,64 of the container main 6 and the contact parts of fore and hind pistons 81,82. So, the processing procedure can be simplified to save time and costs.

Also, accurate and precise selection of flow channels can be achieved merely by controlling linear and reciprocal movement of the cylinder spindle 80 of the cylinder 8. So there will be no shortcomings in the prior art, wherein ball valves in a conventional four-way valve are driven by rotating cylinder but not rotated to desired positions, thereby resulting in deviation and influence to the volume of flow.

The fore end face 811 and hind end face 812 of the fore piston 81, and the fore end face 821 and hind end face 822 of the hind piston 82, connected to the cylinder spindle 80 of the cylinder 8 in the container main 6 are made of rubber materials, and a pad unit 70 of satisfactory airtight sealing performance is fastened to the top margin of the container main 6 to have satisfactory airtight sealing performance.

What is claimed is:

1. A type of four-way valve, having two inlets and two outlets, comprising:
A container main, divided by four partition boards into five spaces, wherein a through hole is provided on each sidewall of a foremost space and a hindmost space and connected with a hind connecting pipe and a fore connecting pipe of a three-way pipe, each of the partition boards having a vent groove to permit connection of the spaces;
A sealing cover, hermetically covered on a top of the container main, and fastened to the container main by tightening members;
A cylinder, fastened to a front side of the container main, having a cylinder spindle penetrating four spaces from a fore side and connected with a fore piston and a hind piston with a fore end face and a hind end face as sealing faces, the fore piston and the hind piston respectively located in a second space and a fourth space of the container main, a length of inside hollow of the second space and a thickness of the fore piston having a difference approximately equal to a difference between a length of inside hollow of the fourth space and a thickness of the fore piston.

2. A type of four-way valve of claim 1, characterized in that: the fore end face and hind end face of the fore piston and the fore end face and hind end face of the hind piston connected to the cylinder spindle of the cylinder at a front part of the container main are made of rubber or other material having satisfactory airtight sealing performance.

3. A type of four-way valve of claim 1, characterized in that: a pad unit is fastened to a top margin of the container main, the pad unit being made of rubber or other material having satisfactory airtight sealing performance.
